(19) United States
(12) Patent Application Publication
(10) Pub. No.: US 2025/0002173 A1
(43) Pub. Date: Jan. 2, 2025

(54) SYSTEM AND METHOD FOR ROCKET LANDING STABILIZATION

(71) Applicant: ARGO ROCKET MARINE, INC., San Diego, CA (US)

(72) Inventor: George Parker Shinn, San Diego, CA (US)

(73) Assignee: ARGO ROCKET MARINE, INC., San Diego, CA (US)

(21) Appl. No.: 18/757,052

(22) Filed: Jun. 27, 2024

Related U.S. Application Data
(60) Provisional application No. 63/524,005, filed on Jun. 29, 2023.

(51) Int. Cl. B64F 1/02

(52) U.S. Cl. CPC B64F 1/029

(57) ABSTRACT

A ground or ship-based rocket landing stabilization system designed to stabilize rockets upon vertical propulsive landing. The rocket landing stabilization system integrates advanced stabilization mechanisms with sensor-based position monitoring, eliminating the necessity for large landing legs and thereby reducing the rocket's weight, leading to increased payload capacity. This enhances overall operational efficiency, cost-effectiveness, and simplifies rocket manufacturing, resulting in improved reliability.

### CROSS-REFERENCE TO RELATED APPLICATION

This application claims the benefit of U.S. Provisional Patent Application No. 63/524,005, filed Jun. 29, 2023, under 35 U.S.C. 119, and is incorporated by reference herein.

### FIELD OF THE INVENTION

The present invention relates to rocket vertical propulsive landing stabilization systems and methods.

### BACKGROUND OF THE INVENTION

Conventional reusable rocket designs rely on heavy and intricate landing legs for stability during landing leading to substantial weight penalties, restricted payload capacity, and compromised mission capabilities.

### SUMMARY OF THE INVENTION

An aspect of the disclosure involves a ground or ship-based rocket landing stabilization system designed to stabilize rockets upon vertical propulsive landing. The rocket landing stabilization system integrates advanced stabilization mechanisms with sensor-based position monitoring, eliminating the necessity for large landing legs and thereby reducing the rocket's weight, leading to increased payload capacity. This enhances overall operational efficiency, cost-effectiveness, and simplifies rocket manufacturing, resulting in improved reliability.

Another aspect of the disclosure involves a system for a stabilizing a rocket including a fuselage upon vertical propulsive landing, comprising a rocket fuselage securement member; one or more position sensors configured to monitor a position of the rocket in real-time and provide position sensor data; a controller configured to control the rocket fuselage securement member to secure the fuselage of the rocket to stabilize the rocket during landing based on the position sensor data.

One or more implementations of the immediately above aspect of the disclosure includes one or more of the following: a plurality of anchor points that the rocket fuselage securement member is coupled with; the plurality of anchor points each include a support; an adjustable positioning cable extending from the support towards the rocket so that a plurality of adjustable positioning cables extend from the plurality of supports towards the rocket; a cinching cable looped around the positioning cables; one or more winches configured to control tension in the positioning cables and the cinching cable; the controller is configured to control the one or more winches to make precise adjustments to the tension in the positioning cables and the cinching cable to stabilize the fuselage of the rocket during landing; the position sensors comprise one or more of inertial measurement units, accelerometers, gyroscopes, radars, laser-based distance sensors or cameras; the one or more winches are electronically or hydraulically controlled to adjust tension in the positioning cables and the cinching cable based on the position sensor data; a landing area for the rocket and the plurality of supports are positioned in a square arrangement around the landing area to provide balanced stabilization; each positioning cable includes an end and the rocket fuselage securement member includes a plurality of cradles at the ends of the positioning cables, the plurality of cradles configured to securely engage the fuselage of the rocket, accommodating different rocket sizes and configurations; the controller is configured to analyze the position sensor data, determine optimal cable tension adjustments, and provide feedback for continuous stabilization during landing; and/or the fuselage of the rocket includes structural elements, and the cinching cable and/or cradles are configured to engage the structural elements to suspend the rocket above a landing area; and/or the system is part of a floating landing pad.

Another aspect of the disclosure involves a method for stabilizing a rocket upon vertical propulsive landing using a system for a stabilizing a rocket including a fuselage upon vertical propulsive landing comprising a rocket fuselage securement member; one or more position sensors configured to monitor a position of the rocket in real-time and provide position sensor data; a controller configured to control the rocket fuselage securement member to secure the fuselage of the rocket to stabilize the rocket during landing based on the position sensor data, comprising engaging the fuselage of the rocket with rocket fuselage securement member; adjusting pressure on the rocket fuselage securement member with the rocket fuselage securement member based on the position sensor data; monitoring the position of the rocket in real-time using the one or more position sensors; making precise adjustments to the rocket fuselage securement member to stabilize the rocket and prevent tip-over incidents.

One or more implementations of the immediately above aspect of the disclosure includes one or more of the following: a plurality of anchor points that the rocket fuselage securement member is coupled with; the plurality of anchor points each include a support; an adjustable positioning cable extending from the support towards the rocket so that a plurality of adjustable positioning cables extend from the plurality of supports towards the rocket; a cinching cable looped around the positioning cables; one or more winches configured to control tension in the positioning cables and the cinching cable; the controller is configured to control the one or more winches to make precise adjustments to the tension in the positioning cables and the cinching cable to stabilize the fuselage of the rocket during landing; the position sensors comprise one or more of inertial measurement units, accelerometers, gyroscopes, radars, laser-based distance sensors or cameras; the one or more winches are electronically or hydraulically controlled to adjust tension in the positioning cables and the cinching cable based on the position sensor data; a landing area for the rocket and the plurality of supports are positioned in a square arrangement around the landing area to provide balanced stabilization; each positioning cable includes an end and the rocket fuselage securement member includes a plurality of cradles at the ends of the positioning cables, the plurality of cradles configured to securely engage the fuselage of the rocket, accommodating different rocket sizes and configurations; the controller is configured to analyze the position sensor data, determine optimal cable tension adjustments, and provide feedback for continuous stabilization during landing; the fuselage of the rocket includes structural elements, and the cinching cable and/or cradles are configured to engage the structural elements to suspend the rocket above a landing area; and/or the system is part of a floating landing pad; a method for stabilizing a rocket upon vertical propulsive landing using the system comprising deploying the positioning cables from the supports towards the rocket upon touchdown; engaging the fuselage of the rockets with the cradles using the positioning cables; adjusting tension in the positioning cables and the cinching cable based on the position sensor data using the one or more winches; monitoring the rocket's position in real-time using the position sensors; making precise adjustments to the cable tension to stabilize the rocket and prevent tip-over incidents; the cable tension adjustments are made dynamically and continuously during the landing phase based on the real-time position sensor data; synchronizing the stabilization process by pulling the cradles together using the cinching cable to maintain optimal stability; the stabilization process is automated using an algorithm that analyzes the position sensor data and controls the one or more winches to achieve and maintain stability during landing; and/or landing legs of the rocket are eliminated, resulting in reduced weight and increased payload capacity.

### BRIEF DESCRIPTION OF THE DRAWINGS

FIG. 1 is a perspective view of an embodiment of a rocket landing stabilization system in a cinched position;

FIG. 2 is a perspective view of the rocket landing stabilization system of FIG. 1 and shows the rocket landing stabilization system in an open position;

FIG. 3 is an enlarged perspective view of pole, positioning and cinching cables of the rocket landing stabilization system of FIG. 1;

FIG. 4 is a perspective view of the rocket landing stabilization system of FIG. 1 and shows the rocket landing stabilization system as a ship-based rocket landing stabilization system.

FIG. 5 is a block diagram of an embodiment of electronics of the rocket landing stabilization system;

FIG. 6 is a block diagram illustrating an example wired or wireless processor enabled device that may be used in connection with various embodiments described herein.

### DETAILED DESCRIPTION OF THE EMBODIMENTS OF THE INVENTION

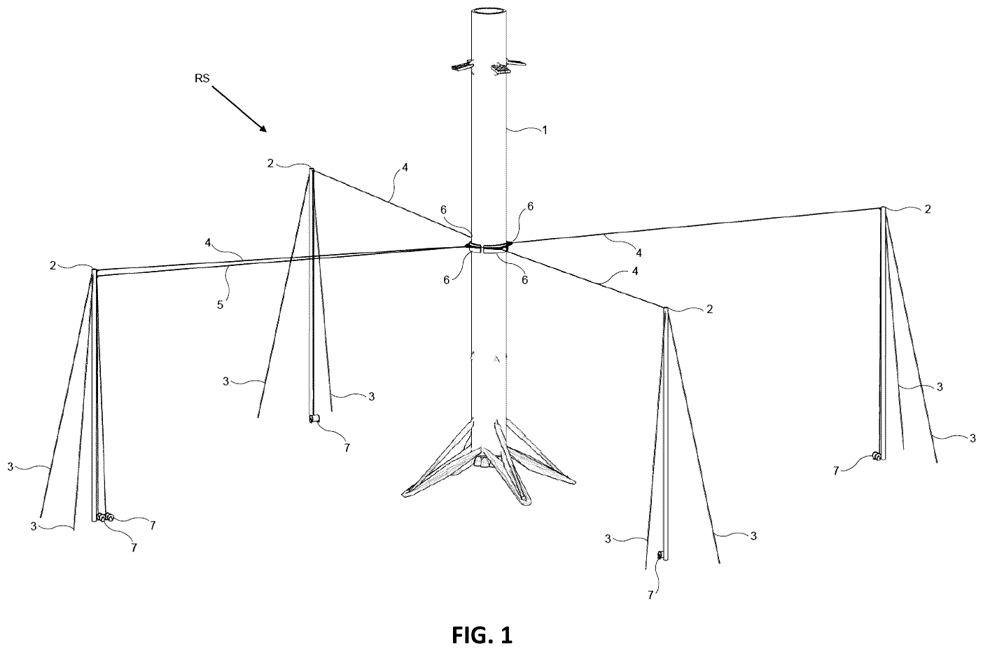

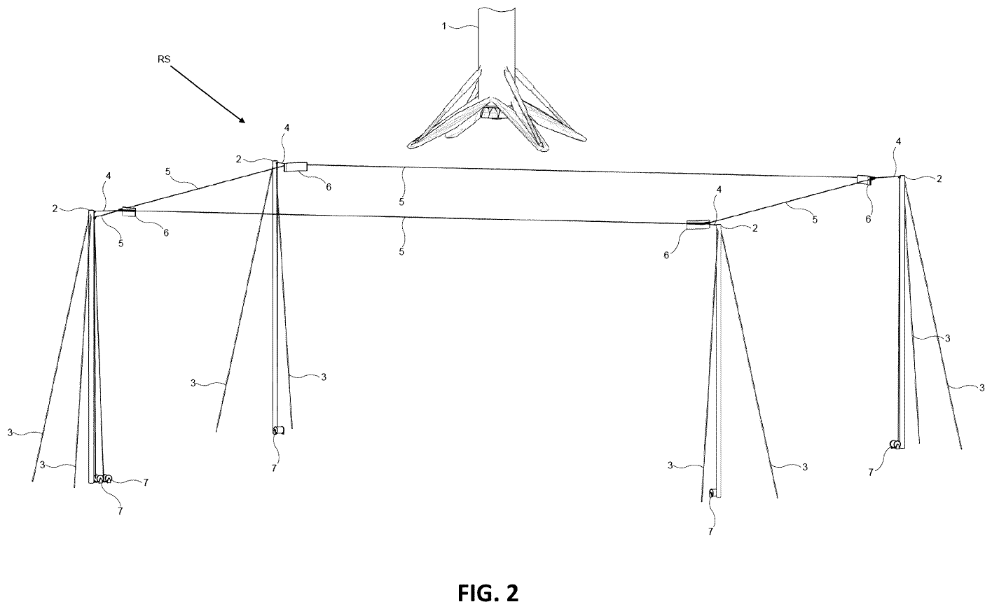

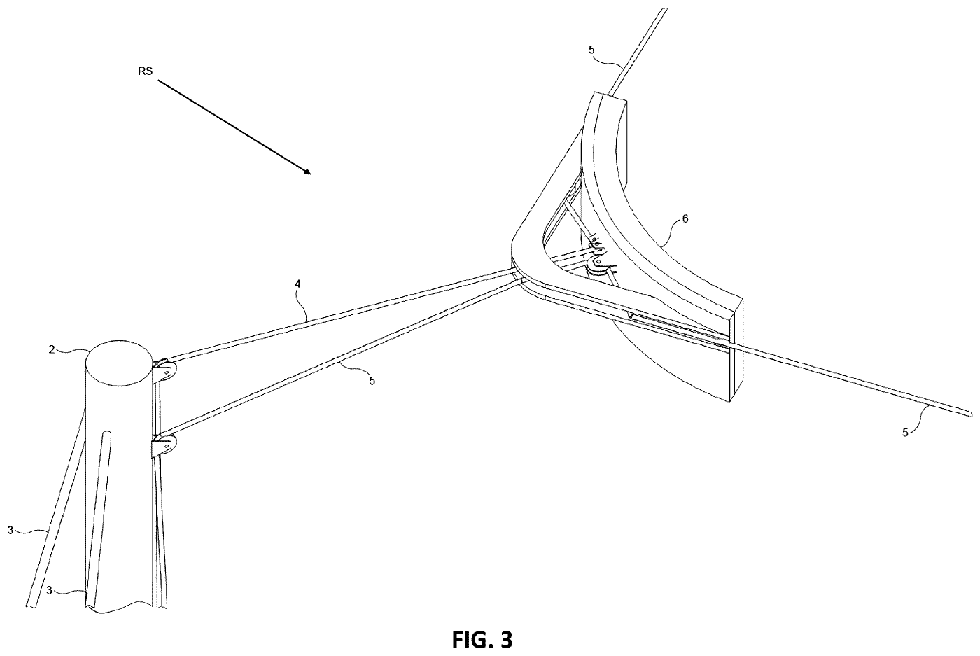

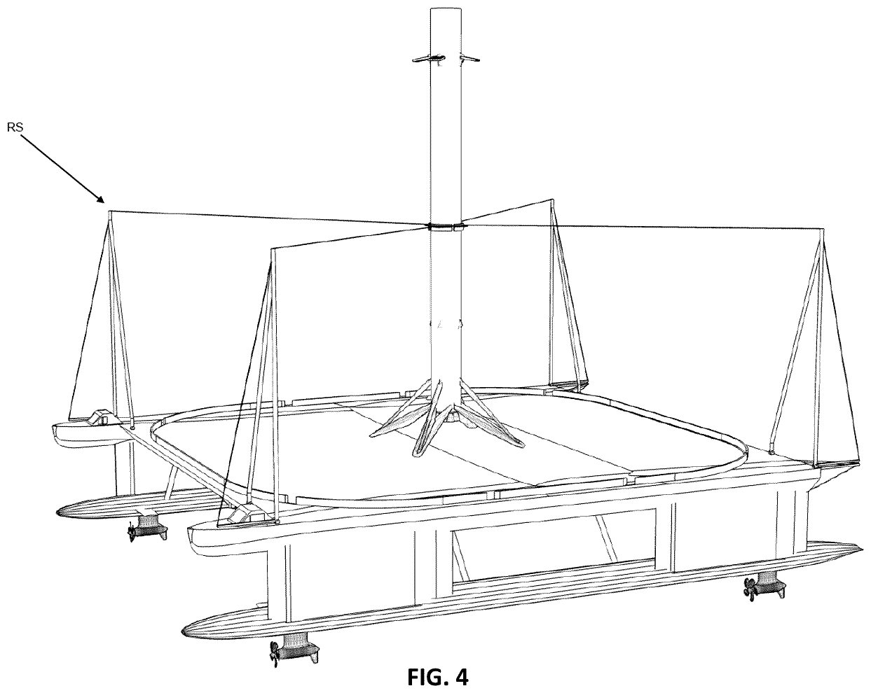

With references to FIGS. 1-5, an embodiment of a rocket landing stabilization system RS will be described. In the following description, for purposes of explanation, numerous specific details are set forth in order to provide a thorough understanding of the embodiments of the present invention. It will be evident, however, to one skilled in the art that the embodiments of the present invention may be practiced without certain specific details.

The embodiments of the present invention as described herein are to be considered an exemplification of the invention and are not intended to limit the invention to the specific embodiments illustrated by the figures or description below. The embodiments of the present invention will now be described by referencing the appended figures representing preferred embodiments.

The rocket landing stabilization system RS for a rocket 1 comprises a plurality of supports/poles 2 and support/pole supporting lines/cables 3 positioned around the perimeter of the landing area serving as anchor points for positioning cables 4 that extend inward towards the rocket 1. Attached to the ends of the positioning cables 4 are rocket fuselage securement member(s)/cradles 6 to securely engage the rocket's fuselage. A cinching cable 5 loops around the cradles 6, pulling them inward toward one another. A system of winches 7 controls the lengths of positioning cables 4 and the cinching cable 5 in a coordinated manner.

In use, prior to touchdown, the cradles 6 are in a retracted/undeployed position next to each of their respective poles 2 and the cinching cable 5 is loosened to form an opening for the rocket 1 to descend through. Upon touchdown, the positioning cables 4 are deployed, extending toward the rocket 1 and the cinching cable 5 is simultaneously deployed, tightenings around the cradles 6 until the cradles 6 engage with the rocket's fuselage. To dynamically stabilize the rocket 1, winches 7 control the tension in the positioning cables 4 and cinching cable 5.

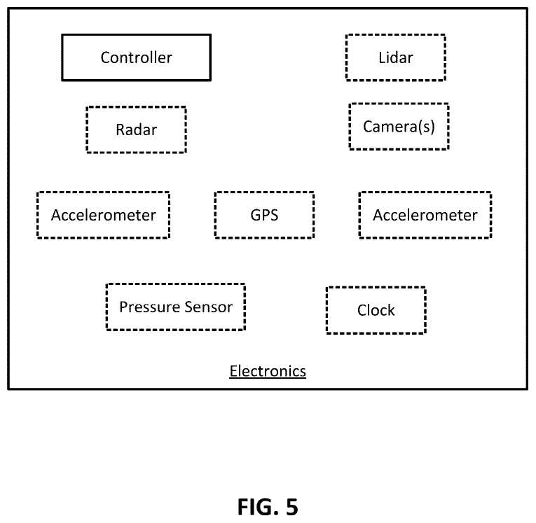

FIG. 5 is a block diagram of an embodiment of electronics of the rocket landing stabilization system. The electronics include a controller and one or more sensors. The controller is informed by the sensors that monitor the rocket's position in real-time (e.g., lidar, radar, cameras, accelerometer, GPS, altimeter, pressure sensor, time sensor (e.g., a clock), etc.). By analyzing the data from these sensors, the winches 7 make precise adjustments, ensuring rapid response and optimal stability to prevent tip-over incidents or damage to the rocket 1.

Furthermore, the rocket landing stabilization system RS may incorporate a dampening system designed to minimize shock loads on the rocket 1 during landing. In this embodiment, the ground or ship-based system is equipped with shock absorbers designed to absorb and dissipate the forces generated when the cradles 6 contact the fuselage of the rocket 1. By effectively dampening the cradle forces, the dampening system provides an additional layer of protection to the rocket's fuselage, structure, and sensitive components.

The cradles 6 are generally shaped to conform to the fuselage of the rocket 1 and may include a layer of padding on the inward facing side. Pressure sensors on the inward facing side may be used to monitor the force the cradle 6 is applying to the rocket fuselage.

Additionally, the rocket landing stabilization system RS may include alternative embodiments where the rocket landing stabilization system RS is a ground or ship-based system, wherein the system RS is configured to catch the rocket 1 and keep it suspended above the landing pad during a vertical propulsive landing. This may be accomplished by the cradles 6 or cinching cable 5 engaging with hooks or other structural elements on the fuselage of the rocket 1. In this embodiment cradles 6 may not be necessary.

The ground or ship-based rocket stabilization system RS presented herein provides a transformative solution for the aerospace industry. Its incorporation of position sensors, along with the efficient arrangement of poles 2, positioning cables 4, cradles 6, cinching cable 5, and winches 7 offers an adaptable alternative to traditional landing leg systems.

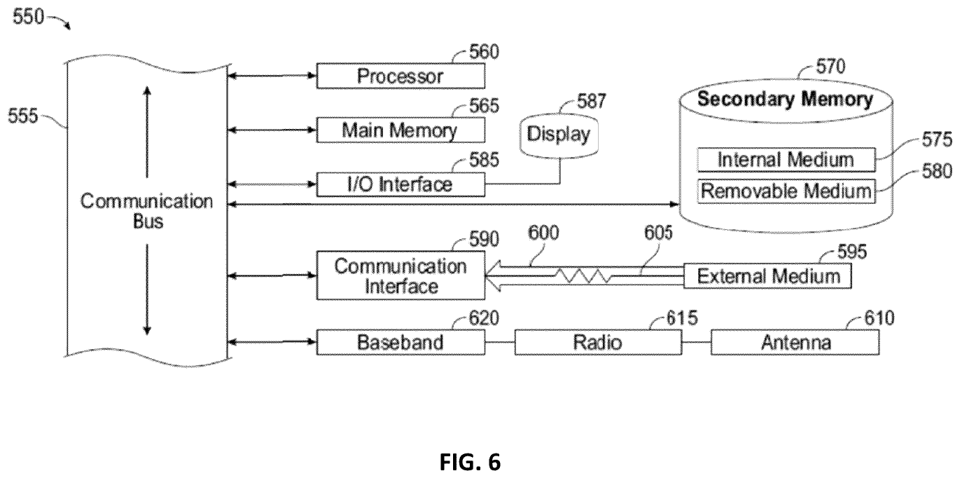

FIG. 6 is a block diagram illustrating an example wired or wireless system 550 that may be used in connection with various embodiments described herein. For example, but not by way of limitation, the system 550 may be used as or in conjunction with the controller of FIG. 5 for controlling the rocket landing stabilization system RS. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display 587. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network (or otherwise described herein). The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I claim:

1. A system for a stabilizing a rocket including a fuselage upon vertical propulsive landing, comprising:
a rocket fuselage securement member;
one or more position sensors configured to monitor a position of the rocket in real-time and provide position sensor data;
a controller configured to control the rocket fuselage securement member to secure the fuselage of the rocket to stabilize the rocket during landing based on the position sensor data.

2. The system of claim 1, further including a plurality of anchor points that the rocket fuselage securement member is coupled with.

3. The system of claim 2, wherein the plurality of anchor points each include a support.

4. The system of claim 3, further including an adjustable positioning cable extending from the support towards the rocket so that a plurality of adjustable positioning cables extend from the plurality of supports towards the rocket.

5. The system of claim 4, further including a cinching cable looped around the positioning cables.

6. The system of claim 5, further including one or more winches configured to control tension in the positioning cables and the cinching cable.

7. The system of claim 6, wherein the controller is configured to control the one or more winches to make precise adjustments to the tension in the positioning cables and the cinching cable to stabilize the fuselage of the rocket during landing.

8. The system of claim 1, wherein the position sensors comprise one or more of inertial measurement units, accelerometers, gyroscopes, radars, laser-based distance sensors or cameras.

9. The system of claim 6, wherein the one or more winches are electronically or hydraulically controlled to adjust tension in the positioning cables and the cinching cable based on the position sensor data.

10. The system of claim 3, further including a landing area for the rocket and the plurality of supports are positioned in a square arrangement around the landing area to provide balanced stabilization.

11. The system of claim 4, wherein each positioning cable includes an end and the rocket fuselage securement member includes a plurality of cradles at the ends of the positioning cables, the plurality of cradles configured to securely engage the fuselage of the rocket, accommodating different rocket sizes and configurations.

12. The system of claim 5, wherein the controller is configured to analyze the position sensor data, determine optimal cable tension adjustments, and provide feedback for continuous stabilization during landing.

13. The system of claim 11, wherein the fuselage of the rocket includes structural elements, and the cinching cable and/or cradles are configured to engage the structural elements to suspend the rocket above a landing area.

14. The system of claim 1, wherein the system is part of a floating landing pad.

15. A method for stabilizing a rocket upon vertical propulsive landing using the system of claim 1, comprising:
engaging the fuselage of the rocket with rocket fuselage securement member;
adjusting pressure on the rocket fuselage securement member with the rocket fuselage securement member based on the position sensor data;
monitoring the position of the rocket in real-time using the one or more position sensors;
making precise adjustments to the rocket fuselage securement member to stabilize the rocket and prevent tip-over incidents.

16. A method for stabilizing a rocket upon vertical propulsive landing using the system of claim 11, comprising:
deploying the positioning cables from the supports towards the rocket upon touchdown;
engaging the fuselage of the rockets with the cradles using the positioning cables;
adjusting tension in the positioning cables and the cinching cable based on the position sensor data using the one or more winches;
monitoring the rocket's position in real-time using the position sensors;
making precise adjustments to the cable tension to stabilize the rocket and prevent tip-over incidents.

17. The method of claim 16, wherein the cable tension adjustments are made dynamically and continuously during the landing phase based on the real-time position sensor data.

18. The method of claim 16, further comprising synchronizing the stabilization process by pulling the cradles together using the cinching cable to maintain optimal stability.

19. The method of claim 16, wherein the stabilization process is automated using an algorithm that analyzes the position sensor data and controls the one or more winches to achieve and maintain stability during landing.

20. A rocket equipped with the system of claim 1, wherein landing legs of the rocket are eliminated, resulting in reduced weight and increased payload capacity.
